(19) United States
(12) Patent Application Publication
(10) Pub. No.: US 2016/0271540 A1
(43) Pub. Date: Sep. 22, 2016

(54) COMPRESSIBLE FILTER MEDIA AND FILTERS CONTAINING SAME

(71) Applicant: Southeast Nonwovens, Inc., Clover, SC (US)

(72) Inventor: Steven F. Nielsen, Charlotte, NC (US)

(21) Appl. No.: 14/950,163

(22) Filed: Nov. 24, 2015

Related U.S. Application Data
(60) Provisional application No. 62/134,077, filed on Mar. 17, 2015.

(51) Int. Cl. B01D 39/02; B01D 24/10

(52) U.S. Cl. CPC B01D 39/02; B01D 24/10

(57) ABSTRACT

A compressible filter media can be formed from discrete fibrous elements adapted for receiving a fluid therethrough and filtering matter contained within the fluid. Each of the fibrous elements can be a three dimensional shape, such as a sphere, cylinder, cone, cube, cuboid, parallelepiped, polyhedron, prism, spheroid, ellipsoid, paraboloid, hyperboloid, and ring.

### CROSS REFERENCE TO RELATED APPLICATIONS

This application claims priority to U.S. Provisional Patent Application No. 62/134077, filed Mar. 17, 2015, which is incorporated by reference herein.

### TECHNICAL FIELD OF INVENTION

The present invention relates to compressible filter media and filters comprising the filter media. One embodiment of the invention comprises compressible filter media comprised of discrete fibrous elements having a three dimensional shape.

### BACKGROUND OF INVENTION

Typical filter media generally fall into two categories based on construction. The first utilizes a sheet type material, usually fibrous in nature, to trap or separate particles from a fluid media. The fluid media can be a gas, such as air or nitrogen, or a liquid such as water or a liquid chemical. These media are typically large in two dimensions—length and width or X and Y plane—and by comparison very small or thin in the thickness or Z direction.

The second type of construction, usually identified as depth filtration, uses a large vessel containing sand, diatomaceous earth or some other material of small particle size. The small particles of sand, and the like, trap the material to be removed from the fluid introduced at the top of the vessel by providing a long tortuous path through the small interstices defined by the particle size of the filter media.

Benefits of the sheet material are that it is light weight, easy to use and can be disposed of easily. A disadvantage of these materials is the thinness of the media, which limits the useful life span of the media. The thinness of the media, to be efficient, necessitates that the pore size be small to capture the insult particles. In doing so, the porosity of the filter media becomes blinded in a short amount of time resulting in less and less fluid being cleaned per given unit of time. As the filter media is blinded over by the filtrate the amount of force required to move the fluid through the sheet increases. This is referred to as pressure drop. Pressure drop measured over time is one of the key attributes in ranking filter media. The longer a filter exhibits a low pressure drop the more valuable the filter is judged to be.

Depth filters are well regarded in certain applications because of the long path the fluid must go through which results in good filtration. These filters can be cleaned and reused a limited number of times by a process called “back flushing”. The down side of this type of filter is disposal of the large volume of sand, diatomaceous earth and the like contained in each filter vessel. For example, the fracking industry uses very large sand filters that constitute several thousands of pounds of sand per filter vessel that then has to be land filled.

### SUMMARY OF INVENTION

One object of the present invention is to provide a low density, highly efficient, fibrous media. Another object of the present invention is to provide a filter media that can provide improved utility for various filter applications. These and other objects of the invention can be achieved by embodiments of the invention disclosed below.

One embodiment of the invention comprises a filter comprising a cartridge having an inlet and an outlet, and a compressible filter media comprised of discrete fibrous elements, each of the discrete fibrous elements comprising a plurality of filter fibers having different deniers.

According to another embodiment of the invention, each of the discrete fibrous elements comprises a plurality of binder fibers bonding the filter fibers and the binder fibers into a cohesive mass.

According to another embodiment of the invention, the filter fibers are in excess, by weight, of the binder fibers.

According to another embodiment of the invention, the binder fibers comprise bicomponent fibers.

According to another embodiment of the invention, each of the filter fibers comprises a core strand and a cover strand surrounding the core strand, the core strand having a denier less than a denier of the cover strand.

According to another embodiment of the invention, the filter fibers comprise a first fiber having a first denier, a second fiber having a denier greater than the first denier, and a third fiber having a denier greater than the second denier.

According to another embodiment of the invention, each of the filter fibers comprises a core, an inner cover layer surrounding the core, and an outer cover layer surrounding the inner cover.

According to another embodiment of the invention, the first fiber resides in the core, the second fiber resides in the inner cover layer, and the third fiber resides in the outer cover layer.

According to another embodiment of the invention, each of the discreet fibrous elements has a length/diameter ratio in the range of 0.1-5:1.

According to another embodiment of the invention, each of the discrete fibrous elements have a three dimensional shape, such as a sphere, cylinder, cone, cube, cuboid, parallelepiped, polyhedron, prism, spheroid, ellipsoid, paraboloid, hyperboloid, and ring.

According to another embodiment of the invention, a compressible filter media comprises discrete fibrous elements adapted for receiving a fluid therethrough and filtering matter contained within the fluid, and each of the fibrous elements comprises a plurality of filter fibers and having a three dimensional shape.

According to another embodiment of the invention, each of the discrete fibrous elements have a three dimensional shape, such as a sphere, cylinder, cone, cube, cuboid, parallelepiped, polyhedron, prism, spheroid, ellipsoid, paraboloid, hyperboloid, and ring.

According to another embodiment of the invention, each of the discrete fibrous elements includes a plurality of binder fibers bonding the filter fibers and the binder fibers into a cohesive mass. The filter fibers are in excess, by weight, of the binder fibers.

According to another embodiment of the invention, each of discreet fibrous element can have a length/diameter ratio in the range of 0.1-5:1.

According to another embodiment of the invention, the filter fibers comprise a first fiber having a first denier, a second fiber having a denier greater than the first denier, and a third fiber having a denier greater than the second denier. Each of the filter fibers can be comprised of a core, an inner cover layer surrounding the core, and an outer cover layer surrounding the inner cover. The first fiber resides in the core, the second fiber resides in the inner cover layer, and the third fiber resides in the outer cover layer.

A method of filtering a fluid includes providing a cartridge having an inlet and an outlet, and a compressible filter media contained within the cartridge. The filter media comprises a plurality of discrete fibrous elements, in which each element comprises a plurality of filter fibers and binder fibers. The binder fibers adapted for bonding the filter fibers and the binder fibers into a cohesive mass. A fluid containing filterable matter is passed through the inlet of the cartridge, and the fluid is extracted from the outlet of the cartridge with the filterable matter removed from the fluid by the filter media.

### BRIEF DESCRIPTION OF THE DRAWINGS

FIG. 1 is a perspective view of a filter media according to a preferred embodiment of the invention;

FIG. 2 is a perspective view of a filter apparatus according to a preferred embodiment of the invention; and

FIG. 3 is another perspective view of the filter apparatus of FIG. 2.

### DETAILED DESCRIPTION OF PREFERRED EMBODIMENTS OF INVENTION AND BEST MODE

Compressible filter media according to a preferred embodiment of the invention comprises a low density, highly efficient, fibrous media having a low Z to XY plane ratio, low pressure drop and is easy to recycle. The filter media has attributes of both a depth filter and a sheet filter, and provides improved utility for several filter applications.

The filter media can comprise a fiber or fiber and particulate blend formed into a low density three dimensional shape that provides a longer torturous path similar to standard depth filters. The filter media has the ease of use of sheet filter media along with the ability to recycle the filter components at the end of its life cycle.

The fibers can be chosen from various polymers and/or inorganic fiber sources. The choice of fiber can be determined by the fluid to be filtered and the size of the material to be removed. Examples of polymeric fibers include, but are not limited to, polyethylene terephthalate (PET), polypropylene (PP), polyethylene (PE), polyphenylene sulfide (PPS), polyethylene imine (PEI), polyphenylsulfone (PPSU), nylon, and cellulose based fibers. In addition to homofil fibers, bicomponent fiber types including, but not limited to, concentric core sheath, excentric core sheath, splittable pie wedge, and island-in-the-sea fibers can be used.

Non-polymeric fibers include, but are not limited to, glass, basalt, carbon, and ceramic. In addition to the fibrous components, the filter media can include particulate materials such as activated carbon particles or other materials that provide a useful function in the removal of contaminants.

Selection of the fiber diameter and cross section are critical to the filtration performance of the filter media. The filter media can be formed from either staple fibers or continuous tow or filament.

According to a preferred embodiment of the invention, a staple fiber based process uses a carding process to open and blend (if using more than one fiber), and collect the resulting web into a sliver. This sliver can be introduced into a machine such as the machine described in U.S. Pat. No. 3,065,505 issued Nov. 27, 1962 to Pratt et. al., which is incorporated herein. This machine, initially intended to produce cotton balls from sliver, will produce a low density ball or cylinder shape (depending on the width of the sliver) that has dimensions in the range of 1.5 inches by 2 inches and weighing about 1.5 to 2 grams.

The above process can be used where multiple slivers can be introduced into the machine of U.S. Pat. No. 3,065,505 (“Pratt machine”) where each sliver is made with a different fiber. The slivers are introduced one on top of the other. For example, three slivers can be used. One sliver can be made with 6 dpf (denier per filament) PET fiber, the second made with 15 dpf PET fiber, and the third made from 45 dpf PET fiber. The slivers can be introduced into the Pratt machine with the 6 dpf fiber on the 15 dpf which is on the 45 dpf. The slivers can be rolled so that the 6 dpf fiber ends up in the center of the ball, surrounded by the 15 dpf, which in turn is surrounded by the 45 dpf. The resulting ball therefore has filtration gradient through the cross section of the ball. Augmenting the filtration gradient caused by fiber diameter is the fact that the density of the ball varies with the highest density in the center.

Alternatively, the filter media can be produced without use of the Pratt machine. According to another embodiment of the invention, a sliver or multiple slivers can be introduced into a heated tube of a predetermined shape, such as round, square, trilobal, or triangular. This bonds the fibers together resulting in a continuous rod which can be cut to the desired width.

According to an embodiment of the invention, fibers of different deniers (and/or cross sections) can be blended and carded together to form a single sliver. For example, a single sliver can be formed by blending and carding together a plurality of fibers at a blend ratio of 60% by weight fifteen denier fibers, 20% six denier fibers, and 20% two denier bicomponent binder fiber. Such a construction is suitable for use in water filtration.

Alternatively, a continuous fiber in tow form rather than carding or otherwise using a staple fiber process, can be used to make a web. According to a preferred embodiment of the invention, crimped tow can be deregistered and spread using a treaded roll machine. Once the web is formed it can be collected in sliver form and made into a ball or other shape using the above process examples.

Alternatively, direct spinning processes, such as meltblowing or spunbonding, can be used to produce sliver material.

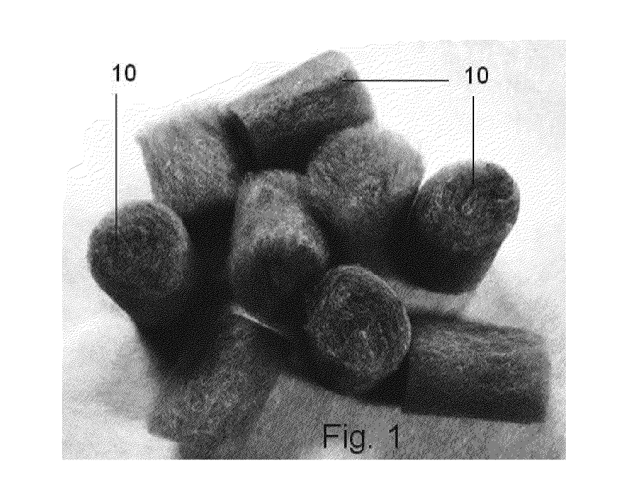

According to a preferred embodiment of the invention, the compressible filter media can be comprised of a plurality of discrete fibrous elements having a three dimensional shape, such as cylindrical, as shown at reference numeral 10 in FIG. 1. The fibrous elements can be a variety of three dimensional shapes, such as a sphere, cylinder, cone, cube, cuboid, parallelepiped, polyhedron, (e.g., pyramid, tetrahedron, octahedron, dodecahedron, icosahedron, etc.), prism, spheroid, ellipsoid, paraboloid, hyperboloid, ring, and combinations thereof. Preferably, each of the fibrous elements 10 have a length/diameter (L/D) ratio in the range of 0.1-5:1. In one embodiment of the invention, the fibrous element 10 can be substantially coin shaped. That is, a cylinder having a length that is shorter than its diameter.

Each of the discrete fibrous elements 10 can be comprised of a plurality of filter fibers and binder fibers. The binder fibers bond the filter fibers and the binder fibers into a cohesive mass. The filter fibers are in excess, by weight, of the binder fibers. The binder fibers can be bicomponent fibers.

Each of the filter fibers can comprises a core, an inner cover layer surrounding the core, and an outer cover layer surrounding the inner cover. Preferably, the inner cover layer has a denier greater than the core, and the outer cover layer has a denier greater than the inner cover layer. Varying the denier of each layer produces specific filtration properties.

According to another embodiment of the invention, each layer can be comprised of fibers having different cross sectional shapes, such as round, cruciform, trilobal, pentalobal and flat. Varying the cross section in each layer can change the flow characteristics allowing for more complete particle capture and/or segregate captured particles by one type of fiber, while other fibers stay clear keeping the pressure drop low.

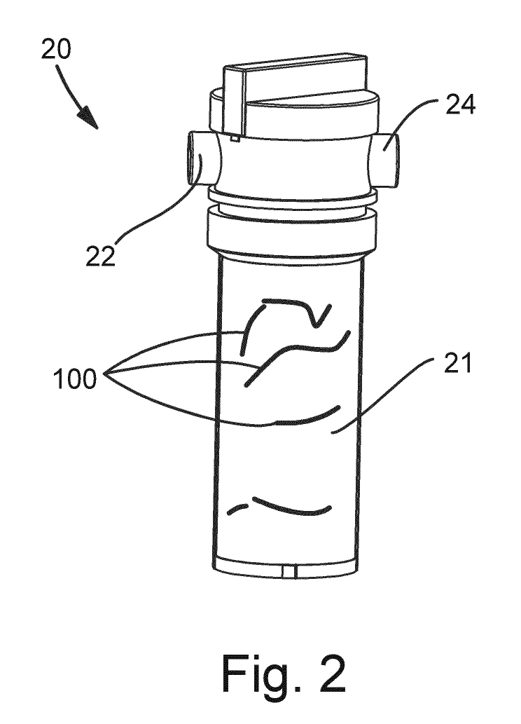

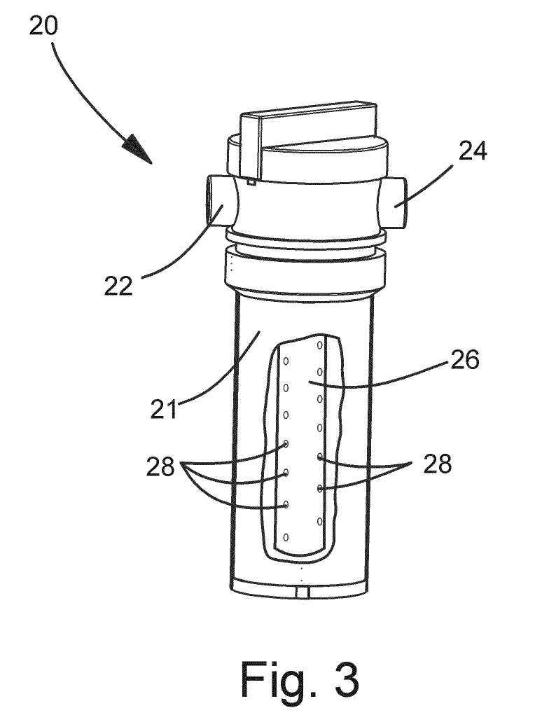

According to another preferred embodiment of the invention, the fibrous elements 10 can be used in a filter apparatus, such as the filter cartridge illustrated in FIGS. 2 and 3, and shown generally at reference numeral 20. As shown in FIG. 2, the filter cartridge 20 comprises an elongate housing 21 that contains compressible filter media 100, which can be comprised of the fibrous elements 10, shown in FIG. 1. The filter cartridge 20 includes an inlet 22 and an outlet 24. The filter cartridge 20 includes an exit pipe 26 having openings formed therein, as shown in FIG. 3. (FIG. 3 shows the filter cartridge 20 with the filter media 100 removed to clearly show the exit pipe 26.) Filter media 100 surrounds the exit pipe 26, and the exit pipe 26 is in communication with the outlet 24. A fluid containing filterable matter is received through the inlet 22 of the filter cartridge 20. The filterable matter is separated from the fluid by the filter media 100. The filtered fluid is received through the openings 28 of the exit pipe 26, and is extracted from the outlet 24 of the cartridge 20.

Filter media and methods of making and using same are described above. Various changes can be made to the invention without departing from its scope. The above description of various embodiments and best mode of the invention are provided for the purpose of illustration only and not limitation—the invention being defined by the claims and equivalents thereof.

What is claimed is:

1. A filter apparatus comprising a cartridge having an inlet and an outlet, and containing compressible filter media comprising discrete fibrous elements, each of the discrete fibrous elements comprising a plurality of filter fibers having different deniers.

2. The filter apparatus according to claim 1, wherein each of the discrete fibrous elements comprises a plurality of binder fibers bonding the filter fibers and the binder fibers into a cohesive mass.

3. The filter apparatus according to claim 2, wherein the filter fibers are in excess, by weight, of the binder fibers.

4. The filter apparatus according to claim 2, wherein the binder fibers comprise bicomponent fibers.

5. The filter apparatus according to claim 1, wherein each of the filter fibers comprises a core strand and a cover strand surrounding the core strand, the core strand having a denier less than a denier of the cover strand.

6. The filter apparatus according to claim 1, wherein the filter fibers comprise a first fiber having a first denier, a second fiber having a denier greater than the first denier, and a third fiber having a denier greater than the second denier.

7. The filter apparatus according to claim 6, wherein each of the filter fibers comprises a core, an inner cover layer surrounding the core, and an outer cover layer surrounding the inner cover.

8. The filter apparatus according to claim 7, wherein the first fiber resides in the core, the second fiber resides in the inner cover layer, and the third fiber resides in the outer cover layer.

9. The filter apparatus according to claim 1, wherein each of the discreet fibrous elements has a length/diameter ratio in the range of 0.1-5:1.

10. The filter apparatus according to claim 1, wherein each of the discrete fibrous elements have a shape selected from the group consisting of a sphere, cylinder, cone, cube, cuboid, parallelepiped, polyhedron, prism, spheroid, ellipsoid, paraboloid, hyperboloid, and ring.

11. A filter medium comprising discrete fibrous elements adapted for receiving a fluid therethrough and filtering matter contained within the fluid, each of the fibrous elements comprising a plurality of filter fibers and having a three dimensional shape.

12. The filter medium according to claim 11, wherein each of the discrete fibrous elements have a shape selected from the group consisting of a sphere, cylinder, cone, cube, cuboid, parallelepiped, polyhedron, prism, spheroid, ellipsoid, paraboloid, hyperboloid, and ring.

13. The filter medium according to claim 11, wherein each of the discrete fibrous elements further comprises a plurality of binder fibers bonding the filter fibers and the binder fibers into a cohesive mass, and the filter fibers are in excess, by weight, of the binder fibers.

14. The filter medium according to claim 11, wherein each of the discreet fibrous elements has a length/diameter ratio in the range of 0.1-5:1.

15. The filter medium according to claim 11, wherein the filter fibers comprises a first fiber having a first denier, a second fiber having a denier greater than the first denier, and a third fiber having a denier greater than the second denier.

16. The filter medium according to claim 15, wherein each of the filter fibers comprise a core, an inner cover layer surrounding the core, and an outer cover layer surrounding the inner cover.

17. The filter medium according to claim 16, wherein the first fiber resides in the core, the second fiber resides in the inner cover layer, and the third fiber resides in the outer cover layer.

18. A method of filtering a fluid comprising the steps of:
(a) providing a cartridge comprising an inlet and an outlet, and a compressible filter medium within the cartridge, the compressible filter medium comprising a plurality of discrete fibrous elements, each element comprising a plurality of filter fibers and binder fibers, the binder fibers adapted for bonding the filter fibers and the binder fibers into a cohesive mass;
(b) passing a fluid containing filterable matter through the inlet of the cartridge; and
(c) extracting the fluid without filterable matter from the outlet of the cartridge.

19. The method according to claim 18, wherein each of the discreet fibrous elements has a length/diameter ratio in the range of 0.1-5:1.

20. The method according to claim 18, wherein each of the discrete fibrous elements have a three dimensional shape selected from the group consisting of a sphere, cylinder, cone, cube, cuboid, parallelepiped, polyhedron, prism, spheroid, ellipsoid, paraboloid, hyperboloid, and ring.
